(19) United States
(12) Patent Application Publication
(10) Pub. No.: US 2026/0134075 A1
(43) Pub. Date: May 14, 2026

(54) SECURE IDENTITY VERIFICATION, ACCESS, AND DELIVER STORAGE SYSTEM

(71) Applicant: Jared Nicolay, Mountain View, CA (US)

(72) Inventor: Jared Nicolay, Mountain View, CA (US)

(21) Appl. No.: 19/387,234

(22) Filed: Nov. 12, 2025

Related U.S. Application Data
(60) Provisional application No. 63/719,315, filed on Nov. 12, 2024.

(51) Int. Cl. G06F 21/32; G06Q 30/0601

(52) U.S. Cl. CPC G06F 21/32; G06Q 30/0627

(57) ABSTRACT

In one embodiment, a secure container for temporarily storing a product includes memory configurable to store software-based instructions for controlling the secure container, an identification (ID) device to read an ID card of the user to generate ID data, one or more biometric sensors to capture biometric data from the user, one or more sensors to capture image data of the user, and processing logic coupled to the memory. The processing logic is configurable to execute the software-based instructions to receive ID data from the ID device, to receive the biometric data from the one or more biometric sensors, to receive image data from the one or more sensors, to process the ID data, the biometric data, and the image data to perform multi-factor authentication of an identity of the user that is attempting to access the product stored in the secure container.

### RELATED APPLICATIONS

This application claims the benefit of U.S. Provisional Application No. 63/719,315 filed on Nov. 12, 2024 entitled: SECURE CONTAINER AND METHOD TO PROVIDE A SECURE PRODUCT DELIVERY, which is incorporated by reference herein.

### FIELD OF THE INVENTION

Embodiments of the present disclosure are generally related to a deliver storage system (also referred to as a “secure container” throughout the present disclosure) and a method to provide a secure product delivery using multi-factor authentication.

### BACKGROUND

Due to the popularity of online shopping, numerous types of products are delivered to businesses and homes during various time periods when a buyer may not be available to receive the ordered product. Products delivered outside a business or home can be easily stolen causing a loss of the product to the buyer and additional expenses for the delivery company in attempting to deliver products to the buyer without theft. Restricted products (e.g., alcohol, cannabis, pharmaceutical drugs, high value goods, ammunition) require age or identity verification at time of delivery that can be difficult to verify if the buyer is not available to receive the product.

### SUMMARY

A delivery storage system (e.g., secure container) and method provide a secure product delivery using multi-factor authentication of a user. In one embodiment, a secure container for temporarily storing a product includes memory configurable to store software-based instructions for controlling the secure container and to store biometric data of a user, an identification (ID) device to read an ID card of the user to generate ID data, one or more biometric sensors to capture biometric data from the user, one or more sensors to capture image data of the user, and processing logic coupled to the memory. The processing logic is configurable to execute the software-based instructions to receive ID data from the ID device, to receive the biometric data from the one or more biometric sensors, to receive image data from the one or more sensors, to process the ID data, the biometric data, and the image data to perform multi-factor authentication of an identity of the user that is attempting to access the product stored in the secure container.

Other embodiments are also described. Other features of embodiments of the present invention will be apparent from the accompanying drawings and from the detailed description which follows.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one.

FIGS. 1A and 1B show an embodiment of a secure container or secure unit in accordance with one embodiment.

FIG. 2 illustrates an in-wall secure multi-unit 200 for businesses, apartments, condominiums, etc. in accordance with one embodiment.

FIG. 3 illustrates an indoor system 300 inside a building 380 for a secure container in accordance with one embodiment.

FIG. 4 illustrates an outdoor system 400 outside a building 480 for a secure container in accordance with one embodiment.

FIG. 5 illustrates a hybrid indoor/outdoor system 500 for a secure container in accordance with one embodiment.

FIG. 6 illustrates a block diagram of a secure system 600 for receiving delivery of a product in accordance with one embodiment.

FIGS. 7A and 7B illustrate a flow diagram of operations for using a secure container to authenticate a user with multi-factor authentication in accordance with one embodiment.

FIG. 8 illustrates a flow diagram of operations for using a self-checkout machine to authenticate a user in accordance with one embodiment. The operational flow may be executed by processing circuitry, processing logic (e.g., one or more processing resources) of the self-checkout machine, a user's device, or a cloud entity.

FIG. 9 illustrates a block diagram of a self-checkout machine for enabling purchasing of products including restricted products without needing or involving human staff of a retail store in accordance with one embodiment.

### DETAILED DESCRIPTION

Secure containers (or secure units) and methods of the present design provide or allow a secure product delivery using multi-factor authentication. The containers (or secure units) allow users to receive valuable, restricted and/or regulated substances without a user (e.g., buyer, purchaser) needing to be physically present at an unpredictable time of the delivery. The secure storage container enables delivery without direct human interaction between a delivery person and the user that purchased the product.

In one example, the present design provides a government approved/compliant process and locationally secured delivery receipt with temporary storage container that is equipped with Biometric or Facial Recognition or Dual-Biometric or Facial Recognition and Government issued ID verification (e.g., driver's license, Passport). The storage container includes self-monitoring security, wired, wireless, and/or IOT enabled technologies. The secure container can be a standalone product with linkages to existing infrastructures and technologies.

In contrast, a conventional approach for receiving a product delivery requires a buyer who placed the product order to be physically present to receive a product delivery for real-time age/identity verification from the delivery courier.

In this section several embodiments of the present disclosure are explained with reference to the appended drawings. Whenever the shapes, relative positions and other aspects of the parts described in the embodiments are not clearly defined, the scope of the invention is not limited only to the parts shown, which are meant merely for the purpose of illustration.

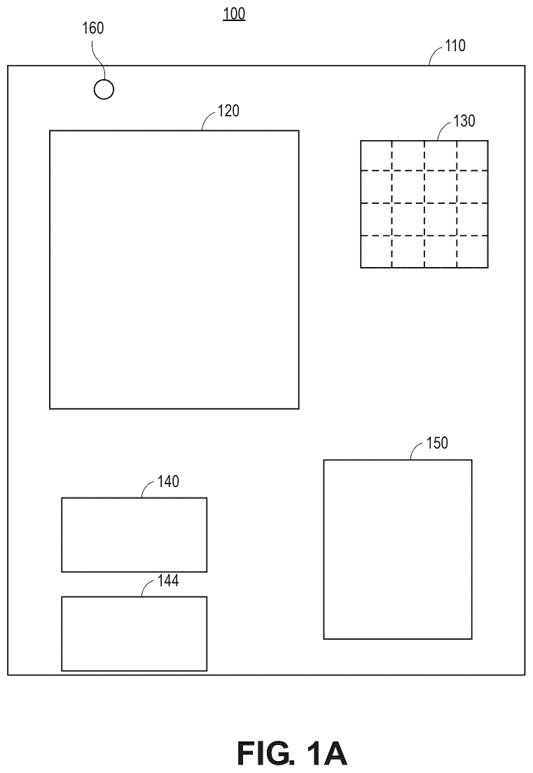

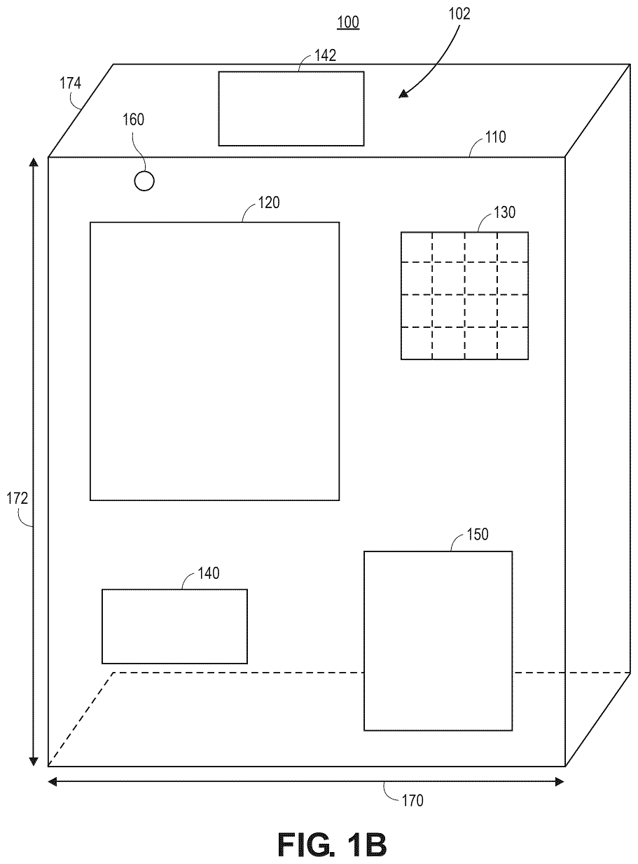

FIGS. 1A and 1B show an embodiment of a secure container (or deliver storage system, or secure unit) in accordance with one embodiment. A “Secure Container” or “Unit” are interchangeably referenced in the accompanying description. The secure container 100 (or unit 100 or delivery storage system 100) includes a metal shelled housing 110 having a width 170, a length or height 172, and depth 174 with a safe-like robustness to protect a product as illustrated in FIG. 1B. In one example, an internal compartment 102 includes a length, a width, or height that is slightly less (e.g., 5% less, 10%, etc.) than a length 170, a height 172, and width 174 of the metal shelled housing 110. Alternatively, the internal compartment 102 includes a width, a length or height, and depth that is significantly less (e.g., 20% less, 40%, etc.) than a length 170, a height 172, and width 174 of the metal shelled housing 110. The secure container 100 includes a display device 120 (e.g., touch screen, analog/digital), a key pad 130, an ID reader 140 to read an ID card (e.g., Government ID Card, Passport, etc.), biometric scanner 150 (e.g., hand or finger, retinal, etc.), and cameras 160 (e.g., security & facial recognition cameras). The secure container provides a computer/mechanical interface with optional IoT, wired, and/or wireless transmission technology enabled interface system. The secure container is customizable in all possible dimensional size parameters for securely receiving and temporarily storing valuable and/or restricted and/or regulated substances including but not limited to Alcohol, Cannabis, fireworks or pharmaceuticals, etc. Any wireless technology or wireless circuitry described herein can be implemented in combination with wired technology or replaced with wired technology.

The secure container 100 includes fault, failure, and error monitoring systems and/or sensors 144 to ensure the container or unit integrity remains intact. In one example, the fault, failure, and error monitoring system and/or sensors 144 will generate anti-tampering alarms in the event of an attempted non-authorized break into the container. Specifically, an optional audible alarm and/or flashing lights can be turned off or on in the event a non-authorized user tries to break into the container, attempts to disconnect a power source or enters the wrong ID, or has incorrect biometric inputs, etc. Local authorities or security can be notified of the attempted non-authorized break into the container.

Optionally, the secure container 100 includes a standard power source 142 or in one example the power source is an environmentally friendly/renewable/sustainable power source 142 via lunar or solar panels, mini-hydro or mini-wind, which would include plug-in auxiliary power as well as an optional fail-safe battery back-up. The power source 142 may have any location in the secure container. In some embodiments, to ensure secure containment, all power grid-based wiring can be either buried below ground or in-wall to further secure/prevent easy tampering).

In some embodiments, for any of the secure containers disclosed herein, the secure container includes a front side or top loading access door that are orientationally applicable based on the various individual dimensional and locational use-case form-factors of the secure storage compartments.

An optional ultraviolet (e.g., UV-C) disinfect light option can be utilized for the internal compartment and the keypad/touch screen interface for any embodiments described herein to reduce the spread of microbial diseases. UV-C is a type of ultraviolet light with a wavelength of 200-280 nanometers that is germicidal, meaning the light can inactivate microorganisms like bacteria, viruses, and fungi. The UV-C works by damaging the microorganisms'DNA, preventing them from reproducing and causing disease. UV-C disinfection is used to sanitize surfaces, water, and air. The secure container for any embodiments described herein may also include a potential secondary weather covering for the user interface to protect against any cold, hot, rainy, snowy weather, etc. The secure container for any embodiments described herein can include optional electronic protection against heat, cold and water/moisture as well.

Any of the secure storage compartments and interface design described herein cover all dimensional and aesthetic/cosmetic variations of architectures, geometries with the individual standalone, locker or P.O. Box-style storage customizable to individual service needs. Likewise, this definition of secure containers and internal storage compartments covers all variation of edge or corner radius/radii and angles based on the specific overarching design, with internal baseline dimensions ranging from 7 inches in Length (L)/X-value or depth by 4 inches in Width (W)/Y-value by 4 inches in Height (H)/Z-Value, +/−2 inches to minimally accommodate small individual deliveries of pharmaceutical, medicinal or recreational controlled substances or valuables to larger options of 20 inches in Length (L)/X-value or depth by 25 inches in Width (W)/Y-value by 19 inches in Height (H)/Z-Value, +/−5 inches accommodate full cold shipped boxes or large alcohol bottles or multiple cases of alcoholic drink cans or bottles and other larger valuables. This definition also includes any configuration of the X/Y/Z and L/W/H dimensions within, under or beyond said range as well, should larger sizes become necessary. Internal dimensions are not necessarily indicative or correspondent to the external dimensions or design beyond applicably fitting within the external device and/or compartment. Internal dimensions should also be inclusive of any added insulation for temperature regulation.

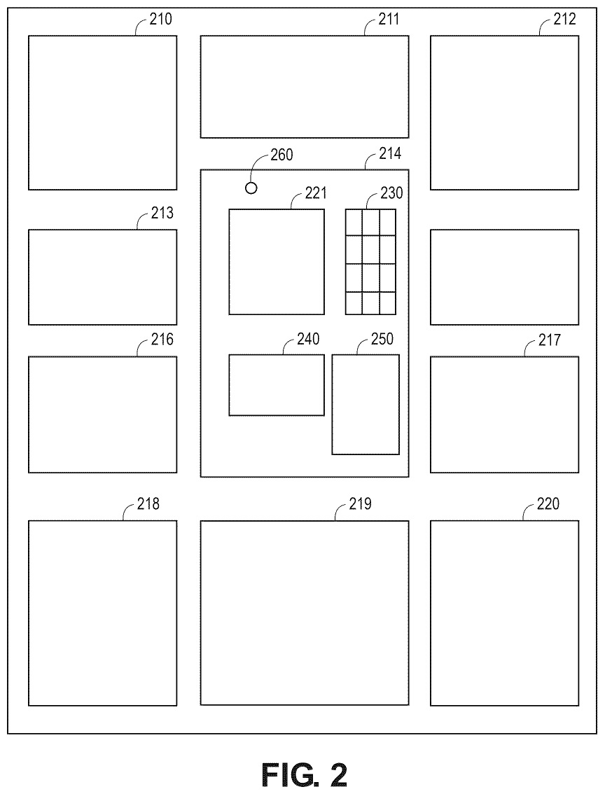

A standalone secure container is illustrated in FIGS. 1A and 1B while an in-wall secure multi-unit 200 for businesses (e.g., multi-unit for in-store pre order pickup for any product including a controlled product like pharmaceuticals, etc.), apartments, condominiums, etc. is illustrated in FIG. 2 in accordance with one embodiment. The multi-unit can be a locker or parcel room-style system with an accompanying single access for a user. Each unit 210-220 includes a display device 221 (e.g., touch screen, analog/digital), a key pad 230, an ID reader 240 to read an ID card (e.g., Government ID Card, Passport, etc.), biometric scanner 250 (e.g., hand or finger, retinal, etc.), and cameras 260 (e.g., security & facial recognition cameras) to provide an Age/Identity verification system for all secure containers. The multi-unit 200 includes a hardwired power source with a back-up battery in case of tampering or temporary power failure.

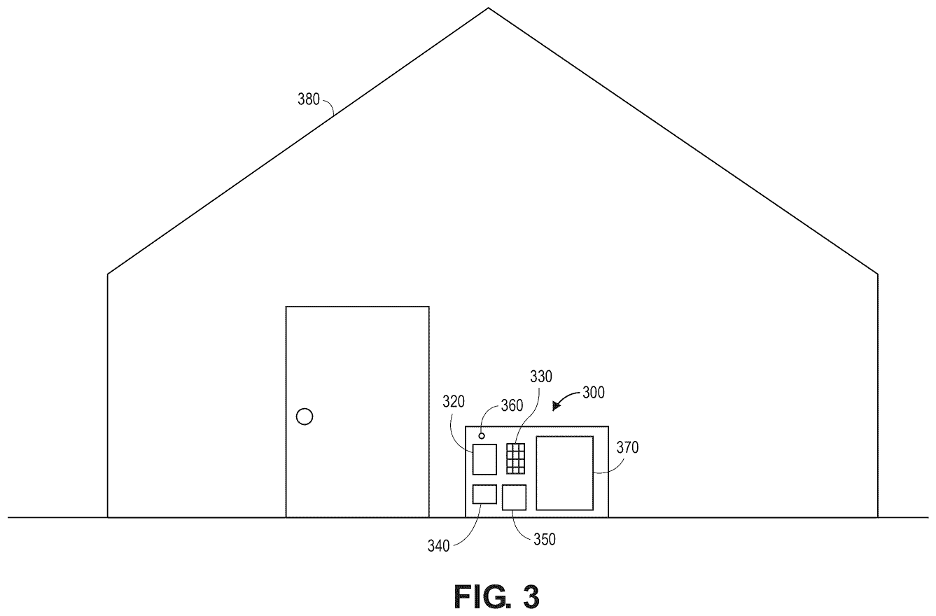

FIG. 3 illustrates an indoor system 300 inside a building 380 for a secure container in accordance with one embodiment. The secure container 302 can be located in an entrance-way or foyer placed standalone unit variation of the present design overview. In one example, the secure container 302 includes similar components (e.g., a display device 320 (e.g., touch screen, analog/digital), a key pad 330, an ID reader 340 to read an ID card or document (e.g., Government ID Card, Passport, etc.), biometric scanner 350 (e.g., hand or finger, retinal, etc.), and cameras 360 (e.g., security & facial recognition cameras) as described above for the secure container of FIGS. 2 and 3. The secure container 302 can include a hardwired power source and secure container door 370.

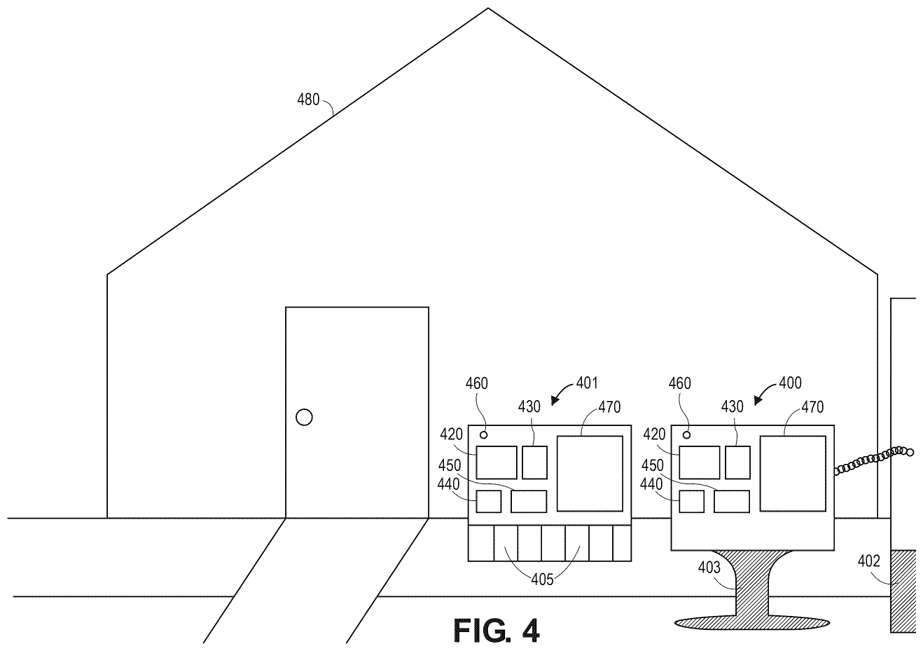

FIG. 4 illustrates an outdoor system 400 outside a building 480 for a secure container in accordance with one embodiment. The outdoor system 400 can be tethered to a structure (e.g., ground structures 402 and 403, a wall structure, a pole, a tree) or a heavily weighted version of the present design as illustrated as weighted system 401 can be anchored by weighted bottom 405. In one example, the outdoor system 400 and weighted system 401 each include similar components (e.g., a display device 420 (e.g., touch screen, analog/digital), a key pad 430, an ID reader 440 to read ID cards or documents (e.g., Government ID Card, Passport, etc.), biometric scanner 450 (e.g., hand or finger, retinal, etc.), and cameras 460 (e.g., security & facial recognition cameras) as described above for the secure container of FIGS. 1-3. The outdoor system 400 and 401 can include a hardwired power source, a solar power source, and a secure container door 470.

### Hybrid for Standalone structure Home/Residences/Business

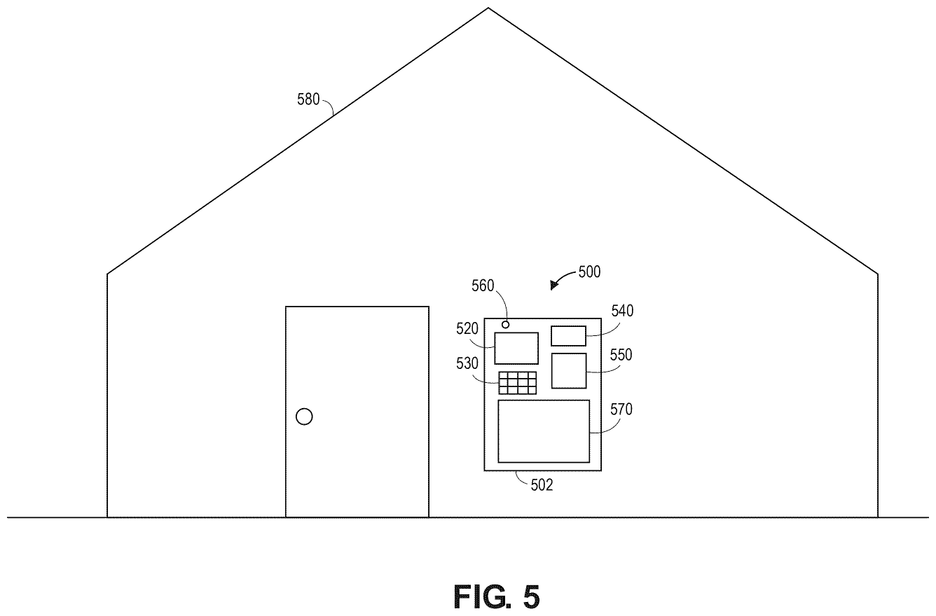

FIG. 5 illustrates a hybrid indoor/outdoor system 500 for a secure container in accordance with one embodiment. The hybrid indoor/outdoor system 500 can be mounted in a built-in wall 502 of a building 580 with a dual or single-sided access door version of the present design. In one example, the system 500 includes similar components (e.g., a display device 520 (e.g., touch screen, analog/digital), a key pad 530, an ID reader 540 to read an ID card or document (e.g., Government ID Card, Passport, etc.), biometric scanner 550 (e.g., hand or finger, retinal, etc.), and cameras 560 (e.g., security & facial recognition cameras) as described above for the secure container of FIGS. 1-4. The system 500 can include a hardwired power source, a solar power source, and a secure container door 570.

In one example, a receiving door is located inside the system 500 with one or more of the key pad 530, the ID reader 540 to read an ID card or document (e.g., Government ID Card, Passport, etc.), and the biometric scanner 550 (e.g., hand or finger, retinal, etc.) being inside for internal secure receipt by an occupant of the building.

In another example, the components of the system 500 can be outside or inside or only the drop off technology for delivery driver is outside with personal identification technology and internal door on inside of building for secure receipt to avoid theft of a product being delivered.

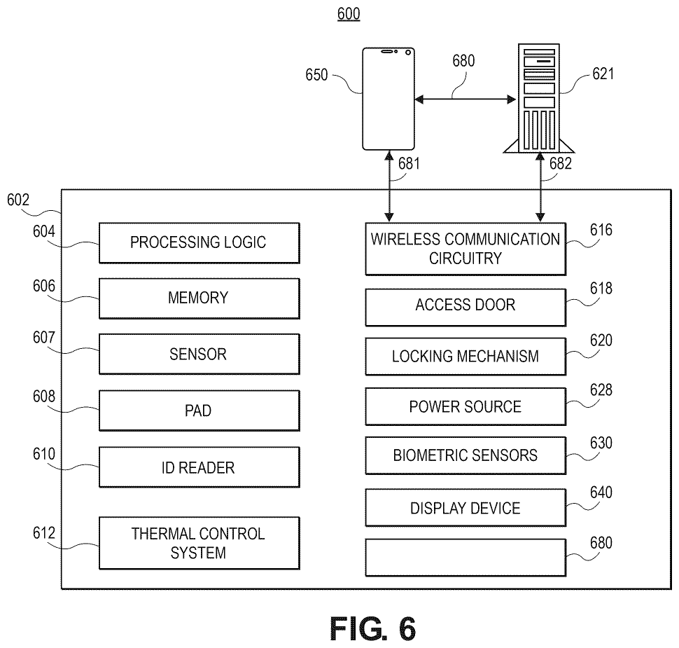

FIG. 6 illustrates a block diagram of a secure system 600 for receiving delivery of a product in accordance with one embodiment. The secure system 600 (e.g., secure container) includes a client device 650, a cloud entity 621, and a secure container 602 that wirelessly or with wired technology communicate with each other via bidirectional communication links 680-682. The secure container 602 includes processing logic 604 (e.g., a hardware-based processor, microcontroller, etc.), a memory 606, sensor(s) 607, a key pad 608 (e.g., key pad 130, 230, 330, 430, 530), an ID reader 610 to read ID cards or documents (e.g., ID scanner 140, 240, 340, 440, 540), an optional thermal control system 612 to provide heating or cooling for a temperature setting of the inside of the container 602, wireless communication circuitry 616 (e.g., RF circuitry for RF communications), a locking mechanism 620, a power source 628, biometric sensors 630 (e.g., biometric scanner 150, 250, 350, 450, 550), and a display device 640 (e.g., display device 120, 220, 320, 420, 520). In one example, the optional thermal control system 612 includes passive or active cooling and/or defined temperature regulation via but not limited to insulated walls, in-ground storage, removal ice/cold packs or electronic refrigeration. This ensures any applicably cold stored product, perishable or item can be safely stored if pick-up is delayed—with optional hot food delivery option storage without refrigeration enabled.

The processing logic 604 controls electronically operated components of the secure container 602. The memory 606 may be a non-volatile memory such as a flash drive or SSD, and stores software-based instructions for controlling the secure container. A volatile memory may also be included. The memory can also store biometric data of an authorized user so the processor can verify that an authorized person is attempting to access the box, and subsequently control the locking mechanism 620 to unlock.

One or more sensors 607 can include a time of flight sensor, one or more cameras (e.g., cameras 160, 260, 360, 460, 560), a LIDAR sensor, or a sonar sensor. The thermal control system 612 may include electronics, a compressor, an evaporator, a condenser, refrigerant fluid, an expansion valve, a fan, and/or other components that may be used to generate cool or warm air for the secure container.

Wireless communication circuitry 616 may be provided along with an antenna and/or transceiver. The wireless communication circuitry 616 may be configured to implement communication via Wi-Fi, LTE, 4G, 5G, Bluetooth, NFC, or other types of wireless communication. The wireless communication circuitry 616 may communicate with a client device 620 (e.g., mobile cellular device, tablet device, smart watch, etc.), a delivery agent's smartphone or mobile electronic device, or a cloud entity 621 via the communication links 680-682. Of course, the user could also communicate with the secure container via an electronic tablet, smartwatch, desktop computer, laptop, etc. by way of the wireless communication circuitry 616. The wireless communication circuitry 616 may also communicate with a smartphone or other electronic device directly via Bluetooth or NFC instead of routing communication through a server of the cloud entity.

The locking mechanism 620 operates to mechanically lock an access door 618 to the secure container to prevent unauthorized persons from accessing contents inside the container. The locking mechanism 620 may be electronically controlled by the processing logic.

The power source 628 may include a standard electrical cable that connects to a wall-based plug and receives AC power from the grid. The power source may also include power conversion circuitry for converting the AC power to DC power for electronic components such as the processor. The power source may also include a battery backup such as a lithium ion battery in addition to the standard power plug. Solar panels for a solar based power source may also be included in addition to the AC and battery backup power sources.

One or more biometric sensors 630 may also be included. A biometric sensor captures biometric data from a person who is attempting to access the secure container and obtain the product(s) stored therein. The biometric sensors obtain biometric data (e.g., touch input, fingerprint, tone of voice, change in heart rate, facial gestures, facial characteristics, emotional condition, etc.) of the user. Thus, the biometric sensor(s) may be disposed on the exterior of the secure container at any location that is user accessible. The processing logic may control the biometric sensor(s) 630 and receive data generated by the biometric sensor(s) 630, and subsequently process the biometric data to confirm an identity of a person attempting access. The biometric sensor(s) 630 may be implemented as a camera that captures images of a user's face, so that the processor logic can perform facial recognition. The biometric sensor(s) 630 could alternatively be a fingerprint sensor that scans a thumb or other finger of a user to perform identity verification. In detail, the fingerprint scanner could include an optical sensor, a capacitive sensor, or an ultrasonic sensor, any one of which can scan the finger and produce a digital image. The biometric sensor(s) 630 could also be a microphone that captures a user's voice pattern. That is, the captured facial image, the captured fingerprint, or the captured voice pattern can be compared to a pre-stored facial image, a pre-stored fingerprint/thumbprint, or a pre-stored voice pattern in order to verify a user's identity quickly and automatically. Other types of biometric identification, such as iris recognition or retinal scans could also conceivably be performed, as long as the biometric sensor(s) 630 can quickly and accurately identify a user. A combination of biometric ID methods can be implemented, such as the combination of facial recognition and fingerprint scanning: in this case there would be multiple biometric sensors.

A display device 6400 may also be included with the secure container. The display device may be disposed on the exterior of the secure container at any exterior location, and the display may display information regarding the contents of the secure container or instructions for how to access the secure container. The display device may display an access code screen whereby correct entry of the access code is required to access products stored within the secure container. The display device could also display various other images such as an interior temperature reading and it may be implemented as a small LCD screen. The key pad 608 may simply be an alphanumeric access code panel with physical buttons for entering digits or characters that permits a user to unlock the delivery box when the correct alphanumeric or numeric code is entered.

Although the processing logic can locally process the output from the biometric sensor(s) so as to perform identity verification, the processing logic can also operate to send the data generated by the biometric sensor(s) to a cloud entity 621, where the biometric data can be processed by the cloud server, and the cloud server verifies the identity, and transmits the results to the processing logic. That is, the identity verification can be performed locally on the delivery box 100 or remotely in the cloud server. The cloud server may be useful if the identity verification requires a relatively large degree of processing power that is difficult for the local processing logic to handle.

In one embodiment, a machine-accessible non-transitory medium 680 contains executable computer program instructions which when executed by processing logic cause the processing logic to perform any of the methods discussed herein. While the machine-accessible non-transitory medium 680 is shown in an exemplary embodiment to be a single medium, the term “machine-accessible non-transitory medium” should be taken to include a single medium or multiple media (e.g., a centralized or distributed database, and/or associated caches and servers) that store the one or more sets of instructions. The term “machine-accessible non-transitory medium” shall also be taken to include any medium that is capable of storing, encoding or carrying a set of instructions for execution by the machine and that cause the machine to perform any one or more of the methodologies of the present invention. The term “machine-accessible non-transitory medium” shall accordingly be taken to include, but not be limited to, solid-state memories, optical and magnetic media, and carrier wave signals.

The present design provides one or more of Age verification and Identity Verification for restricted products with requirements as defined by a respective government's requirements for restricted and/or regulated substances including but not limited to Alcohol, Cannabis, fireworks or pharmaceutical drugs, etc.

The present design provides multi-Factor Authentication (e.g., two factor authentication, three factor authentication, etc.) in order to authenticate a person as being the buyer that ordered a delivered product. Biometric or Facial Recognition and Government ID or Passport Scanner are example types of authentication (e.g., ID Scanners, Finger Print Scanners and/or Retinal Scanners and/or Cameras for Facial Recognition).

In one example, single factor authentication includes Biometric or Facial Recognition.

Structurally, the exterior construction of each secure container/container assembly will be constructed of an applicably tamper-free, safe-like metal design, to a degree sufficient to demonstrate reasonable inaccessibility by unauthorized individuals or entities, as defined realistically to any other secure holding location relative to existing government laws/ordinances. For Surveillance, cameras of the secure container capture images to indicate motion. Also, proximity activated camera(s) with or without light sensitive automatic flash for use in the dark capture any approaching users and/or individuals tampering with a secure container. The secure container may include software to delete any surveillance imaging of confirming delivery or receipt of contents at a configurable time period after delivery of a product to reduce memory storage space needed in the secure container. For standalone home/residence units, this memory feature can be turned off when not using the secure container. For apartments or condos, this memory feature is optional depending on the applicability of the specific setting. The secure container have wireless communication circuitry is compatible with existing door bell and/or other IoT and/or wireless enabled cameras/technologies and/or wired enabled technologies.

In terms of Locational security, all options outside of a standalone house or residence, should be locationally secure relative to the respective security of their location within units assembled in the wall mounted or standalone secure container(s) inside a standalone house or residence. Outside of standalone house or residence, locational security will require the use of a modified secure container weighted or ground mounted or tethered to a wall or secure object that cannot be removed without the use of heavy machinery.

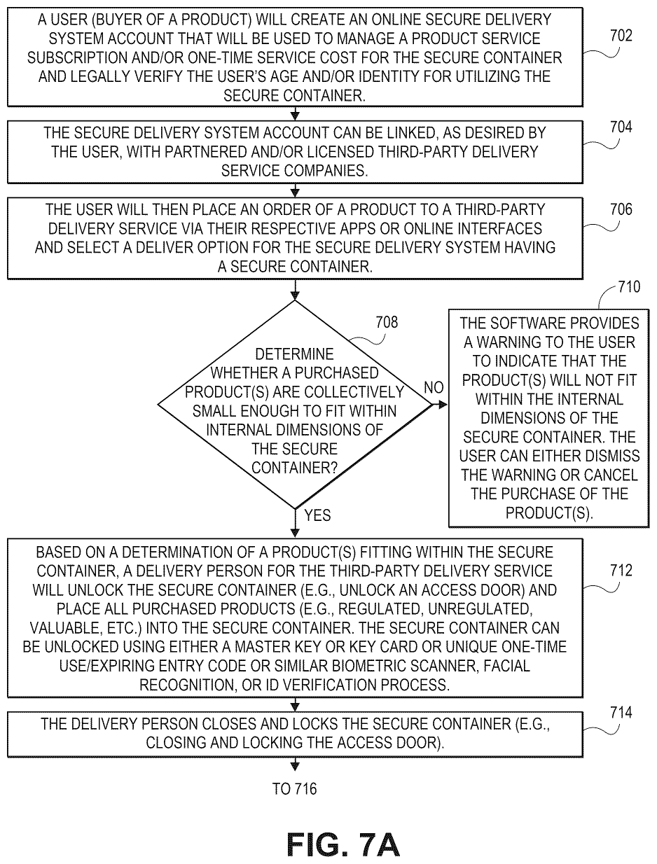

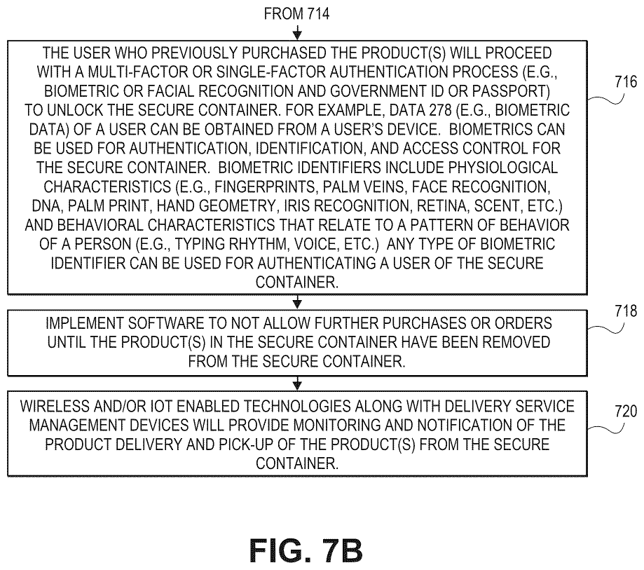

FIGS. 7A and 7B illustrate a flow diagram of operations for using a secure container to authenticate a user in accordance with one embodiment. The operational flow may be executed by processing circuitry, processing logic (e.g., one or more processing resources) of the secure container, a user's device, or a cloud entity. The processing logic may include hardware (circuitry, dedicated logic, etc.), software (such as is run on a general purpose computer system or a dedicated machine or a device), or a combination of both. In one embodiment, processing logic of a secure container performs at least some of the operations of method 700.

At operation 702, a user (buyer of a product) will create an online secure delivery system account that will be used to manage a product service subscription and/or one-time service cost for the secure container (or delivery storage system, multi-unit container such as in-store multi-unit container, lockers, etc.) and legally verify the user's Age and/or Identity for utilizing the secure container. A user's device creates the online secure delivery system account.

At operation 704, the secure delivery system account can be linked, as desired by the user, with partnered and/or licensed third-party delivery service companies. At operation 706, the user will then place an order of a product to a third-party delivery service via their respective apps or online interfaces and select a deliver option for the secure delivery system having a secure container.

At optional operation 708, the method includes enabling software (e.g., software of secure delivery system account, software of the secure container, software of the third-party delivery service, etc.) to determine whether a purchased product(s) are collectively small enough to fit within internal dimensions of the secure container. If so, then the method proceeds with purchasing of the product(s).

If not, then at operation 710 the software provides a warning to the user to indicate that the product(s) will not fit within the internal dimensions of the secure container. The user can either dismiss the warning, elect for scheduled delivery, or cancel the purchase of the product(s).

At operation 712, based on a determination of a product(s) fitting within the secure container, a delivery person for the third-party delivery service will unlock the secure container (e.g., unlock an access door) and place all purchased products (e.g., regulated, unregulated, valuable, etc.) into the secure container. The secure container can be unlocked using either a master key or key card or unique one-time use/expiring entry code or similar biometric scanner, facial recognition, or ID verification process. At operation 714, the delivery person closes and locks the secure container (e.g., closing and locking the access door).

At operation 716, the user who previously purchased the product(s) will proceed with a multi-factor or single-factor authentication process (e.g., biometric or facial recognition and government ID or passport) to unlock the secure container. For example, data 278 (e.g., biometric data) of a user can be obtained from a user's device. Biometrics can be used for authentication, identification, and access control for the secure container. Biometric identifiers include physiological characteristics (e.g., fingerprints, palm veins, face recognition, DNA, palm print, hand geometry, iris recognition, retina, scent, etc.) and behavioral characteristics that relate to a pattern of behavior of a person (e.g., typing rhythm, voice, etc.) Any type of biometric identifier can be used for authenticating a user of the secure container.

At operation 718, the method will implement software (e.g., software of secure delivery system account, software of the secure container, software of the third-party delivery service, etc.) to not allow further purchases or orders until the product(s) in the secure container have been removed from the secure container. At operation 720, wireless, wired, and/or IoT enabled technologies along with delivery service management devices will provide monitoring and notification of the product delivery and pick-up of the product(s) from the secure container.

### Inclusion of Self-checkout or Pick-up Areas

Where appliable, the computer/technical interface module described herein that enables the multi-factor identity verification access is custom calibratable for plug-in play integration both with respect to the (1) herein defined secure storage compartment(s) for the various dimensional and locational use-case form-factors as well as (2) any pre-existing service oriented devices being utilized with the intention of human-free verification oversite (i.e., directly associated secure storage compartments, online order pick-up lockers, self-checkout machines and where applicably integrated country specific regulated P. O Boxes where applicable sized).

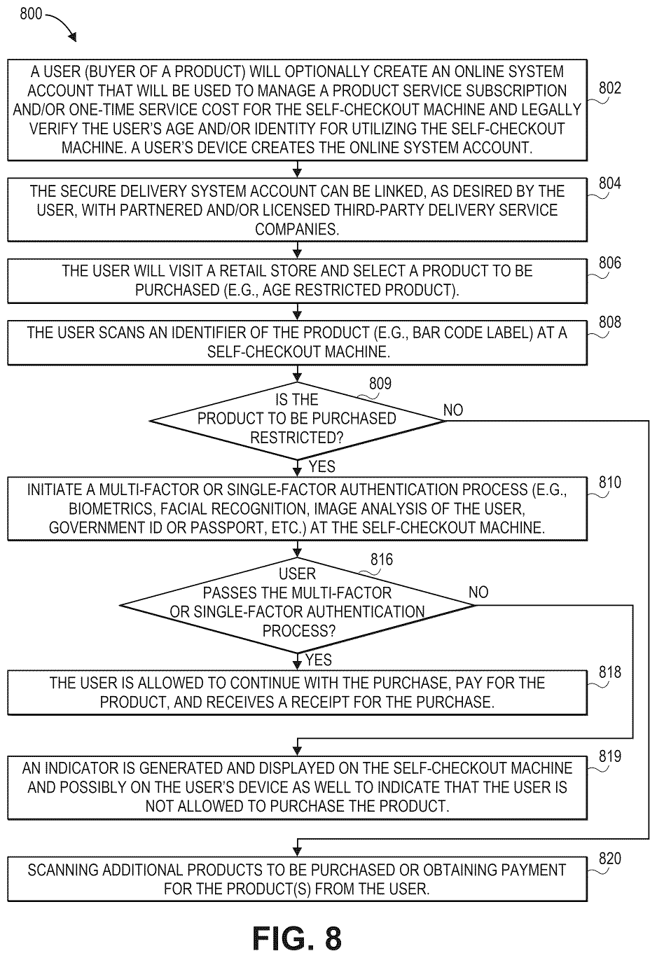

FIG. 8 illustrates a flow diagram of operations for using a self-checkout machine to authenticate a user in accordance with one embodiment. The operational flow may be executed by processing circuitry, processing logic (e.g., one or more processing resources) of the self-checkout machine, a user's device, or a cloud entity. The processing logic may include hardware (circuitry, dedicated logic, etc.), software (such as is run on a general purpose computer system or a dedicated machine or a device), or a combination of both. In one embodiment, processing logic of a self-checkout machine performs at least some of the operations of method 800.

At operation 802, a user (buyer of a product) will optionally create an online system account that will be used to manage a product service subscription and/or one-time service cost for the self-checkout machine and legally verify the user's Age and/or Identity for utilizing the self-checkout machine. A user's device creates the online system account.

At operation 804, the secure delivery system account can be linked, as desired by the user, with partnered and/or licensed third-party delivery service companies. At operation 806, the user will visit a retail store and select a product to be purchased (e.g., age restricted product).

At operation 808, the user scans an identifier of the product (e.g., bar code label) at a self-checkout machine (e.g., self-checkout machine 900), which determines whether the product to be purchased is restricted (e.g., restricted by age of a user, banned from certain users, etc.) at operation 809. If so (restricted product), then this initiates a multi-factor or single-factor authentication process (e.g., biometrics, facial recognition, image analysis of the user, government ID or passport, etc.) at the self-checkout machine at operation 810. If not (no restrictions to sale of the product), then the method proceeds with scanning additional products to be purchased or obtaining payment for the product(s) from the user at operation 820. A sensor (e.g., a camera) for photographing or imaging the bagging area after each product scan can optionally be performed to ensure that the right products being bagged correspond to what products were scanned. The sensor can be integrated with the self-checkout machine or external from the self-checkout machine.

For an example of a restricted product, data (e.g., biometric data) of a user can be obtained from the user or a user's device for the multi-factor or single-factor authentication process. Biometrics can be used for authentication, identification, and access control for the secure container. Biometric identifiers include physiological characteristics (e.g., fingerprints, palm veins, face recognition, DNA, palm print, hand geometry, iris recognition, retina, scent, etc.) and behavioral characteristics that relate to a pattern of behavior of a person (e.g., typing rhythm, voice, etc.) Any type of biometric identifier can be used for authenticating a user to have one or more characteristics (e.g., be of sufficient age, not banned from purchasing alcohol, etc.) for purchasing the age restricted product.

At operation 816, the method determines whether the user passes the multi-factor or single-factor authentication process. If so, then at operation 818, the user is allowed to continue with the purchase, pay for the product, and receives a receipt for the purchase.

If not (fails authentication), then at operation 819 an indicator is generated and displayed on the self-checkout machine and possibly on the user's device as well to indicate that the user is not allowed to purchase the product. Staff from the retail store will then remove the product from the self-checkout machine.

In some embodiments, whether a user has a system account is contingent on a purchasing method. In one example, for prepurchase locker pickup, a user has an account and the in-store locker simply leverages the multi-factor identity verification module. Whether a preexisting account is needed for picking up a product is also dependent on the specific regulatory compliance rules/laws and any pertinent pre-existing available databases for that specific locality (i.e., government IDs and finger prints stored in available databases) Likewise, the secure containers and self-checkout machines of the present disclosure can compare driver license photos with the ID photos, and also with a facial recognition technology vs the other types of biometrics. The present design can utilize pre-populated accounts for security and publicly available data, where applicable.

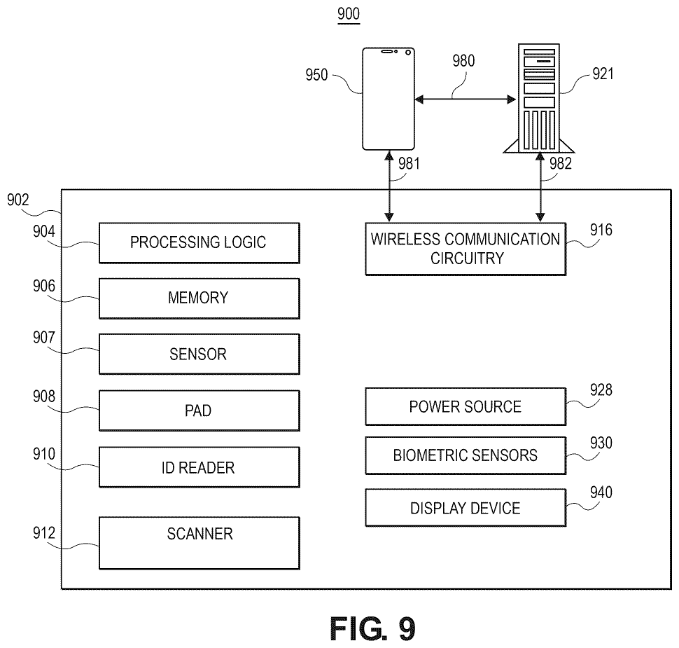

FIG. 9 illustrates a block diagram of a self-checkout machine for enabling purchasing of products including restricted products without needing or involving human staff of a retail store in accordance with one embodiment. The self-checkout system 900 includes a self-checkout machine 902 that can communicate with a client device 950 of a user (or buyer or administrator of the self-checkout system), a cloud entity 921 that wirelessly or with wired technology communicate with each other via bidirectional communication links 680-682. The self-checkout machine 902 includes processing logic 904 (e.g., a hardware-based processor, microcontroller, etc.), a memory 906, sensor(s) 907, an optional key pad 908, an ID reader 910 to read ID cards or documents, a scanning system 912 to scan product identifiers from products to be purchased, wireless communication circuitry 916 (e.g., RF circuitry for RF communications), a power source 928, biometric sensors 930, and a display device 940.

The processing logic 904 controls electronically operated components of the self-checkout machine 902. The memory 906 may be a non-volatile memory such as a flash drive or SSD, and stores software-based instructions for controlling the secure container. A volatile memory may also be included. The memory can also store biometric data of an authorized user so the processing logic can verify that the user is authorized to purchase a product such as a restricted product.

One or more sensors 907 can include a time of flight sensor, one or more cameras, a LIDAR sensor, or a sonar sensor.

Wireless communication circuitry 916 may be provided along with an antenna and/or transceiver. The wireless communication circuitry 916 may be configured to implement communication via Wi-Fi, LTE, 4G, 5G, Bluetooth, NFC, or other types of wireless communication. The wireless communication circuitry 916 may communicate with other devices including a client device 950 (e.g., mobile cellular device, tablet device, smart watch, etc.), or a cloud entity 921 via the communication links 980-982.

One or more biometric sensors 930 may also be included. A biometric sensor captures biometric data from a person who is attempting to purchase product(s) from a retail store. The biometric sensors obtain biometric data (e.g., touch input, fingerprint, tone of voice, change in heart rate, facial gestures, facial characteristics, emotional condition, etc.) of the user. Thus, the biometric sensor(s) may be disposed on the self-checkout machine at any location that is user accessible. The processing logic may control the biometric sensor(s) 930 and receive data generated by the biometric sensor(s) 930, and subsequently process the biometric data to confirm an identity of a person attempting to buy a potentially restricted product. The biometric sensor(s) 930 may be implemented as a camera that captures images of a user's face, so that the processor logic can perform facial recognition. The biometric sensor(s) 930 could alternatively be a fingerprint sensor that scans a thumb or other finger of a user to perform identity verification. In detail, the fingerprint scanner could include an optical sensor, a capacitive sensor, or an ultrasonic sensor, any one of which can scan the finger and produce a digital image. The biometric sensor(s) 930 could also be a microphone that captures a user's voice pattern. That is, the captured facial image, the captured fingerprint, or the captured voice pattern can be compared to a pre-stored facial image, a pre-stored fingerprint/thumbprint, or a pre-stored voice pattern in order to verify a user's identity quickly and automatically. Other types of biometric identification, such as iris recognition or retinal scans could also conceivably be performed, as long as the biometric sensor(s) 930 can quickly and accurately identify a user. A combination of biometric ID methods can be implemented, such as the combination of facial recognition and fingerprint scanning: in this case there would be multiple biometric sensors.

A display device 940 provides a user interface for purchasing products, enabling identity and age authentication of a user (or buyer) for one or more restricted products. The processing logic is configured to execute software-based instructions to determine if the user presently has an impaired state based on processing one or more of the ID data, the biometric data, and the image data.

Some embodiments relate to Example 1 that includes a secure container for temporarily storing a product, comprising memory configurable to store software-based instructions for controlling the secure container and to store biometric data of a user, an identification (ID) device to read an ID card of the user to generate ID data, one or more biometric sensors to capture biometric data from the user, one or more sensors to capture image data of the user, and processing logic coupled to the memory. The processing logic is configurable to execute the software-based instructions to receive ID data from the ID device, to receive the biometric data from the one or more biometric sensors, to receive image data from the one or more sensors, to process the ID data, the biometric data, and the image data to perform multi-factor authentication of an identity of the user that is attempting to access the product stored in the secure container. Example 2 includes the subject matter of Example 1, wherein the secure container is integrated inside a building or built into an exterior wall of the building.

Example 3 includes the subject matter of any of Examples 1-2, further comprising a thermal control system coupled to the processing logic, the thermal control system is configured to heat or cool for an adjustable temperature setting of an internal compartment of the secure container.

Example 4 includes the subject matter of any of Examples 1-3, further comprising wireless communication circuitry coupled to the processing logic, the wireless communication circuitry is configured to transmit wireless communications to a client device or a cloud entity and to receive wireless communication from the client device or the cloud entity.

Example 5 includes the subject matter of any of Examples 1-4, further comprising a locking mechanism coupled to the processing logic, wherein the locking mechanism is electronically controlled by the processing logic to mechanically lock an access door to the secure container to prevent unauthorized persons from accessing contents inside the container.

Example 6 includes the subject matter of any of Examples 1-5, wherein the one or more biometric sensors is configured to capture biometric data including at least two of touch input, fingerprint, tone of voice, change in heart rate, facial gestures, facial characteristics, iris recognition, retinal scan, or emotional condition of the user.

Example 7 includes the subject matter of any of Examples 1-6, wherein the processing logic is configured to compare captured biometric data for the user to a pre-stored facial image, a pre-stored fingerprint or thumbprint, or a pre-stored voice pattern in order to verify a user's identity quickly and automatically.

Example 8 includes the subject matter of any of Examples 1-7, wherein the processing logic is further configured to perform fault, failure, and error monitoring to ensure the secure container integrity remains intact.

Example 9 includes the subject matter of any of Examples 1-8, wherein the processing logic is further configured to perform one or more of age verification and identity verification for restricted products with requirements as defined by a respective government's requirements for restricted or regulated substances.

Some embodiments relate to Example 10 that includes a method to authenticate a user as being authorized to access a secure container, the method comprising receiving, with processing logic, an input to unlock the secure container having a product stored inside of the secure container, and performing, with processing logic of the secure container, a multi-factor authentication process including reading an ID card of the user to generate ID data, capturing, with one or more biometric sensors, biometric data from the user, capturing, with one or more sensors, image data of the user, and processing the ID data, the biometric data, and the image data to perform multi-factor authentication of an identity of the user that is attempting to access the product stored in the secure container.

Example 11 includes the subject matter of Example 10, further comprising receiving biometric data of the user from a user's device, wherein the biometric data is utilized for authentication, identification, and access control for the secure container.

Example 12 includes the subject matter of any of Examples 10-11, wherein biometric identifiers include physiological characteristics including fingerprints, palm veins, face recognition, DNA, palm print, hand geometry, iris recognition, retina, scent and behavioral characteristics that relate to a pattern of behavior of a person with any type of biometric identifier being used for authenticating a user of the secure container.

Example 13 includes the subject matter of any of Examples 10-12, further comprising receiving an input to create a secure delivery system account to manage a product service subscription or one-time service cost for the secure container and legally verifying the user's Age or Identity for utilizing the secure container and linking the secure delivery system account to one or more third-party delivery service companies.

Example 14 includes the subject matter of any of Examples 10-13, further comprising enabling software to determine whether a purchased product of the user is collectively smaller than internal dimensions of the secure container, allowing a purchasing of the product to proceed if the purchased product fits within internal dimensions of the secure container, and providing a warning to the user if the purchased product will not fit within the internal dimensions of the secure container.

Example 15 includes the subject matter of any of Examples 10-14, further comprising enabling software to not allow further purchases or orders until the product in the secure container has been removed from the secure container by the authorized user.

Some embodiments relate to Example 16 that includes a non-transitory computer-readable storage medium embodying a set of instructions, which when executed by processing logic cause the processing logic to receive, with the processing logic, an input to unlock a secure container being capable of storing a product inside of the secure container and perform a multi-factor authentication process including reading an ID card of a user to generate ID data, receive from one or more biometric sensors of the secure container biometric data of the user, receive, from one or more sensors, image data of the user, and process the ID data, the biometric data, and the image data to perform multi-factor authentication of an identity of the user that is attempting to access inside the secure container.

Example 17 includes the subject matter of Example 16, wherein the instructions, which when executed by the processing logic cause the processing logic to receive biometric data of the user from a user's device, wherein the biometric data is utilized for authentication, identification, and access control for the secure container.

Example 18 includes the subject matter of any of Examples 16-17, wherein biometric identifiers include physiological characteristics including fingerprints, palm veins, face recognition, DNA, palm print, hand geometry, iris recognition, retina, scent and behavioral characteristics that relate to a pattern of behavior of a person with any type of biometric identifier being used for authenticating a user of the secure container.

Example 19 includes the subject matter of any of Examples 16-18, wherein the instructions, which when executed by the processing logic cause the processing logic to receive an input to create a secure delivery system account to manage a product service subscription or one-time service cost for the secure container and legally verify the user's Age or Identity for utilizing the secure container and link the secure delivery system account to one or more third-party delivery service companies.

Example 20 includes the subject matter of any of Examples 16-19, wherein the instructions, which when executed by the processing logic cause the processing logic to enable software to determine whether a purchased product of the user is collectively smaller than internal dimensions of the secure container, allow a purchasing of the product to proceed if the purchased product fits within internal dimensions of the secure container, and provide a warning to the user if the purchased product will not fit within the internal dimensions of the secure container.

Some embodiments relate to Example 21 that is a self-checkout machine, comprising memory configurable to store software-based instructions for controlling the self-checkout machine and to store biometric data of one or more users, an identification (ID) device to read an ID card of a user to generate ID data, one or more biometric sensors to capture biometric data from the user, one or more sensors to capture image data of the user, a sensor to read a product identifier of a product to be purchased, and processing logic coupled to the memory. The processing logic is configurable to execute the software-based instructions to receive the product identifier of the product, to receive the ID data from the ID device, to receive the biometric data from the one or more biometric sensors, to receive the image data from the one or more sensors, to process the product identifier to determine if the product is restricted, and to process the ID data, the biometric data, and the image data to perform multi-factor authentication of an identity of the user that is attempting to purchase the product when the product is restricted.

Example 22 includes the subject matter of Example 21, wherein the processing logic is further configured to execute the software-based instructions to determine if the user presently has an impaired state based on processing one or more of the ID data, the biometric data, and the image data. In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A secure container for temporarily storing a product, comprising:
memory configurable to store software-based instructions for controlling the secure container and to store biometric data of one or more users;
an identification (ID) device to read an ID card of a user to generate ID data;
one or more biometric sensors to capture biometric data from the user;
one or more sensors to capture image data of the user; and
processing logic coupled to the memory, wherein the processing logic is configurable to execute the software-based instructions to receive the ID data from the ID device, to receive the biometric data from the one or more biometric sensors, to receive the image data from the one or more sensors, and to process the ID data, the biometric data, and the image data to perform multi-factor authentication of an identity of the user that is attempting to access the product stored in the secure container.

2. The secure container of claim 1, wherein the secure container is integrated inside a building or built into an exterior wall of the building.

3. The secure container of claim 1, further comprising:
a thermal control system coupled to the processing logic, the thermal control system is configured to heat or cool for an adjustable temperature setting of an internal compartment of the secure container.

4. The secure container of claim 1, further comprising:
wireless communication circuitry coupled to the processing logic, the wireless communication circuitry is configured to transmit wireless communications to a client device or a cloud entity and to receive wireless communication from the client device or the cloud entity.

5. The secure container of claim 1, further comprising:
a locking mechanism coupled to the processing logic, wherein the locking mechanism is electronically controlled by the processing logic to mechanically lock an access door to the secure container to prevent unauthorized persons from accessing contents inside the container.

6. The secure container of claim 1, wherein the one or more biometric sensors is configured to capture biometric data including at least two of touch input, fingerprint, tone of voice, change in heart rate, facial gestures, facial characteristics, iris recognition, retinal scan, or emotional condition of the user.

7. The secure container of claim 6, wherein the processing logic is configured to compare captured biometric data for the user to a pre-stored facial image, a pre-stored fingerprint or thumbprint, or a pre-stored voice pattern in order to verify a user's identity quickly and automatically.

8. The secure container of claim 1, wherein the processing logic is further configured to perform fault, failure, and error monitoring to ensure the secure container integrity remains intact.

9. The secure container of claim 1, wherein the processing logic is further configured to perform one or more of age verification and identity verification for restricted products with requirements as defined by a respective government's requirements for restricted or regulated substances.

10. A method to authenticate a user as being authorized to access a secure container, the method comprising:
receiving, with processing logic, an input to unlock the secure container having a product stored inside of the secure container; and
performing, with processing logic of the secure container, a multi-factor authentication process including reading an ID card of the user to generate ID data, capturing, with one or more biometric sensors, biometric data from the user, capturing, with one or more sensors, image data of the user, and processing the ID data, the biometric data, and the image data to perform multi-factor authentication of an identity of the user that is attempting to access the product stored in the secure container.

11. The method of claim 10, further comprising:
receiving biometric data of the user from a user's device, wherein the biometric data is utilized for authentication, identification, and access control for the secure container.

12. The method of claim 10, wherein biometric identifiers include physiological characteristics including fingerprints, palm veins, face recognition, DNA, palm print, hand geometry, iris recognition, retina, scent and behavioral characteristics that relate to a pattern of behavior of a person with any type of biometric identifier being used for authenticating a user of the secure container.

13. The method of claim 10, further comprising:
receiving an input to create a secure delivery system account to manage a product service subscription or one-time service cost for the secure container and legally verifying the user's Age or Identity for utilizing the secure container; and
linking the secure delivery system account to one or more third-party delivery service companies.

14. The method of claim 13, further comprising:
enabling software to determine whether a purchased product of the user is collectively smaller than internal dimensions of the secure container;
allowing a purchasing of the product to proceed if the purchased product fits within internal dimensions of the secure container; and
providing a warning to the user if the purchased product will not fit within the internal dimensions of the secure container.

15. The method of claim 13 further comprising:
enabling software to not allow further purchases or orders until the product in the secure container has been removed from the secure container by the authorized user.

16. A non-transitory computer-readable storage medium embodying a set of instructions, which when executed by processing logic cause the processing logic to:
receive, with the processing logic, an input to unlock a secure container being capable of storing a product inside of the secure container; and
perform a multi-factor authentication process including reading an ID card of a user to generate ID data, receive from one or more biometric sensors of the secure container biometric data of the user, receive, from one or more sensors, image data of the user, and process the ID data, the biometric data, and the image data to perform multi-factor authentication of an identity of the user that is attempting to access inside the secure container.

17. The non-transitory computer-readable storage medium of claim 16, wherein the instructions, which when executed by the processing logic cause the processing logic to:
receive biometric data of the user from a user's device, wherein the biometric data is utilized for authentication, identification, and access control for the secure container.

18. The non-transitory computer-readable storage medium of claim 16, wherein biometric identifiers include physiological characteristics including fingerprints, palm veins, face recognition, DNA, palm print, hand geometry, iris recognition, retina, scent and behavioral characteristics that relate to a pattern of behavior of a person with any type of biometric identifier being used for authenticating a user of the secure container.

19. The non-transitory computer-readable storage medium of claim 16, wherein the instructions, which when executed by the processing logic cause the processing logic to:
receive an input to create a secure delivery system account to manage a product service subscription or one-time service cost for the secure container and legally verify the user's Age or Identity for utilizing the secure container; and
link the secure delivery system account to one or more third-party delivery service companies.

20. The non-transitory computer-readable storage medium of claim 19, wherein the instructions, which when executed by the processing logic cause the processing logic to:
enable software to determine whether a purchased product of the user is collectively smaller than internal dimensions of the secure container;
allow a purchasing of the product to proceed if the purchased product fits within internal dimensions of the secure container; and
provide a warning to the user if the purchased product will not fit within the internal dimensions of the secure container.

21. A self-checkout machine, comprising:
memory configurable to store software-based instructions for controlling the self-checkout machine and to store biometric data of one or more users;
an identification (ID) device to read an ID card of a user to generate ID data;
one or more biometric sensors to capture biometric data from the user;
one or more sensors to capture image data of the user;
a sensor to read a product identifier of a product to be purchased; and
processing logic coupled to the memory, wherein the processing logic is configurable to execute the software-based instructions to receive the product identifier of the product, to receive the ID data from the ID device, to receive the biometric data from the one or more biometric sensors, to receive the image data from the one or more sensors, to process the product identifier to determine if the product is restricted, and to process the ID data, the biometric data, and the image data to perform multi-factor authentication of an identity of the user that is attempting to purchase the product when the product is restricted.

22. The self-checkout machine of claim 21, wherein the processing logic is further configured to execute the software-based instructions to determine if the user presently has an impaired state based on processing one or more of the ID data, the biometric data, and the image data.
